(19) United States
(12) Patent Application Publication
(10) Pub. No.: US 2015/0360591 A1
(43) Pub. Date: Dec. 17, 2015

(54) ROTATIONAL ENERGY ABSORBER AND VEHICLE SEAT WITH A ROTATIONAL ENERGY ABSORBER OF THIS TYPE

(71) Applicant: SUSPA GmbH, Altdorf (DE)

(72) Inventors: Sven RÖLL, Postbauer-Heng (DE); Stefan WALDMÜLLER, Altdorf (DE); Thomas WELKER, Altdorf (DE); Murad EL-AZZEH, Altdorf (DE)

(21) Appl. No.: 14/736,713

(22) Filed: Jun. 11, 2015

(30) Foreign Application Priority Data
Jun. 12, 2014 (DE) 10 2014 211 274.5

(51) Int. Cl. B60N 2/427; B60N 2/44

(52) U.S. Cl. CPC B60N 2/42745; B60N 2/4435

(57) ABSTRACT

A rotational energy absorber for a vehicle seat comprises a rotational axis, an outer tube element arranged centrally with respect to the rotational axis, an inner tube element arranged concentrically in the outer tube element and at least one energy absorption element for absorbing rotational energy, the inner tube element and the outer tube element being arranged rotatably relative to one another about the rotational axis.

### CROSS-REFERENCES TO RELATED APPLICATIONS

This application claims the priority of German Patent Application, Serial No. 10 2014 211 274.5, filed Jun. 12, 2014, pursuant to 35 U.S.C. 119(a)-(d), the content of which is incorporated herein by reference in its entirety as if fully set forth herein.

### FIELD OF THE INVENTION

The invention relates to a rotational energy absorber for a vehicle seat and to a vehicle seat with a rotational energy absorber of this type.

### BACKGROUND OF THE INVENTION

In a motor vehicle, in particular in a car, a passenger is secured by means of a safety belt to a vehicle seat. A torque acts on the backrest of the vehicle seat upon an impact of the vehicle. In order to reduce an adverse effect for the passenger and, in particular, to avoid injuries to the passenger, it is known from the prior art that the backrest should fail on reaching a predetermined torque. A predetermined bending point may be provided for this purpose in the frame of the backrest. The establishing of the predetermined torque by means of the predetermined bending point is imprecise. A slip clutch is generally known as a torque limiter. A slip clutch has a complex construction, has a high weight and is expensive.

### SUMMARY OF THE INVENTION

The invention is based on an object of reducing a health risk to a passenger on a vehicle seat.

The object is achieved by a rotational energy absorber for a vehicle seat comprising a rotational axis, an outer tube element arranged centrally with respect to the rotational axis, an inner tube element arranged concentrically in the outer tube element, and at least one energy absorption element to absorb rotational energy, wherein the inner tube element and the outer tube element are arranged rotatably relative to one another about the rotational axis.

The core of the invention is that a rotational energy absorber is provided for a vehicle seat in a motor vehicle. The rotational energy absorber has an energy absorption element that is suitable to absorb rotational energy. The rotational energy absorber has a rotational axis and an outer tube element arranged centrally with respect to the rotational axis. The outer tube element substantially has an annular cross section oriented perpendicular to the rotational axis. An inner tube element is concentrically arranged in the outer tube element. In particular, the inner tube element is arranged with an outer surface resting flat, at least in portions, on an inner face of the outer tube element. The inner tube element and the outer tube element are connected to one another by a frictional connection and/or positive locking. As soon as an outer torque impressed on the rotational energy absorber reaches or exceeds the frictional force connecting the tube elements, it is possible to rotate the tube elements in relation to one another. The inner tube element and the outer tube element can be rotated relative to one another about the rotational axis. The rotational energy of the rotation of the tube elements in relation to one another is absorbed by the at least one energy absorption element in that the rotational energy is converted into deformation energy and/or heat. By varying the respective size and the number of energy absorption elements, a predetermined torque, at which the rotational energy absorber and therefore the vehicle seat fails, can be adjusted with great precision. The rotational energy absorber allows precise torques to be freely defined, at which a failure of the vehicle seat is to take place. Moreover, torque courses are freely definable. In addition, it can be fixed by means of the rotational energy absorber according to the invention which torque peak loads should, and are permitted, to occur. The damping behavior of the rotational energy absorber is independent of speed. In particular, constant torque courses are possible at variable speed loads. The rotational energy absorber has an uncomplicated and light construction. The rotational energy absorber is economical. The rotational energy absorber is space-saving. The rotational energy absorber can be assembled in an uncomplicated manner. The rotational energy absorber is noise-free during use.

A rotational energy absorber, in which the outer tube element has at least one energy absorption element, allows simplified production of the rotational energy absorber and, in particular, of the outer tube element.

A rotational energy absorber, in which the inner tube element has at least one energy absorption element, simplifies the conversion of the rotational energy into deformation energy and/or heat.

A rotational energy absorber with a plurality of, in particular three, energy absorption elements allows reliable absorption of the rotational energy. The energy absorption elements are arranged in an energy absorption element arrangement along a peripheral line about the rotational axis on the outer tube element and/or on the inner tube element. Two or at least four, in particular at least five, in particular at least six, in particular at least eight, in particular at least ten and, in particular at most 100 energy absorption elements may also be contained in an energy absorption element arrangement. The number and size of the energy absorption elements depends on the predeterminable torque, at which the rotational energy absorber is to fail.

A rotational energy absorber with at least a first energy absorption element arrangement and a second energy absorption element arrangement allows a decoupled, step-wise absorption of rotational energy. In particular, it is possible for the energy absorption elements of the first energy absorption element arrangement, independently of the energy absorption elements of the second energy absorption element arrangement, to absorb rotational energy. The energy absorption element arrangements are arranged spaced apart from one another along the rotational axis. A rotational energy absorber, in which the energy absorption elements of the first energy absorption element arrangement are arranged at a first rotational angle about the rotational axis, which differs from a second rotational angle of the energy absorption elements of the second energy absorption element arrangement, allows a load-adapted construction of the rotational energy absorber.

A rotational energy absorber, in which the at least one energy absorption element is an inwardly or outwardly protruding protrusion projecting radially on the inner tube element and/or on the outer tube element simplifies the production of the energy absorption element. The protrusions are, in particular, configured as a bead, indentation and/or depression and can be formed in an uncomplicated manner in two tubes inserted in one another. The bead is configured as a depression introduced from the outside into the respective tube element. The depression substantially has a slot-like contour. However, other contours, such as, for example, circular or square, are also conceivable. The protrusion may also protrude radially outwardly. In particular when the rotational energy absorber is to be arranged on a shaft, outwardly protruding protrusions are advantageous.

A rotational energy absorber, in which a protrusion of the inner tube element rests over the entire surface on a corresponding protrusion of the outer tube element, improves the energy absorption.

A rotational energy absorber, in which a protrusion of the inner tube element is configured as a free-running protrusion, allows a free-running function of the rotational energy absorber, at least in portions. This means that no energy absorption takes place by means of the rotational energy absorber in a free-running portion, in other words within a free-running angle region about the rotational axis. In this free-running portion, rotational energy can be absorbed, for example by energy absorption elements, in particular of other energy absorption element arrangements. It is thus possible to realize stepped energy absorption in relation to a rotational angle about the rotational axis with the rotational energy absorber. It is this possible to provide a step-wise damping effect depending on the rotational angle. In particular, all the protrusions of an energy absorption element arrangement are configured as a free-running protrusion. In particular, a rotation along the rotational direction about the rotational axis is thus energy absorption-free. The free-running protrusion is, in particular, configured in that the protrusion of the inner tube element, in portions, is arranged spaced apart radially and/or tangentially, in other words in the peripheral direction, from the protrusion of the outer tube element. This means that the protrusion of the inner tube element in particular does not rest over the entire surface on the protrusion of the outer tube element.

A rotational energy absorber with a damping element, in particular with a blockable gas spring, has an improved functionality.

It is a further object of the present invention to provide a vehicle seat, in which the passenger safety is improved.

This object is achieved by a vehicle seat with a seat shell, a backrest connected to the seat shell so as to be rotatable about a rotational seat axis and at least one rotational energy absorber according to the invention.

The core of the invention is that at least one rotational energy absorber is provided in a vehicle seat between a seat shell and a backrest connected to the seat shell so as to be rotatable about a rotational seat axis. In particular, two rotational energy absorbers are provided on the vehicle seat. The advantages of the vehicle seat according to the invention substantially correspond to those of the rotational energy absorber, to the advantages of which reference is hereby made. The vehicle seat according to the invention reduces a load on a passenger using the vehicle seat. When there is an unforeseen event, such as, for example, a spontaneous impact of the motor vehicle, a torque acts on the vehicle seat, which is transmitted from the upper body of a passenger via the safety belt to the backrest. In addition, the vehicle seat according to the invention also makes improved safety possible for a passenger sitting behind the vehicle seat. If the passenger behind the vehicle seat according to the invention impacts without the safety belt fastened, in the event of an impact of the vehicle, on the vehicle seat, he could be injured on the vehicle seat. As the backrest fails in a controlled manner when overstressed, the risk of injury to the passenger without the safety belt fastened behind the seat according to the invention is reduced.

A vehicle seat, in which the rotational seat axis and the rotational axis are arranged coaxially, allows a direct predictability of the predetermined torque.

A vehicle seat, in which the outer tube element of the rotational energy absorber is non-rotatably fastened with respect to the rotational axis on the seat shell, allows an uncomplicated and direct attachment of the rotational energy absorber to the vehicle seat. In particular, the vehicle seat has a rotational energy absorber retainer, which is configured in one piece with the seat shell.

A vehicle seat, in which the inner tube element of the rotational energy absorber is non-rotatably fastened with respect to the rotational axis on the backrest, allows a simplified fastening to the vehicle seat.

A vehicle seat, in which the inner tube element has an assembly portion, which is arranged for non-rotatable connection to the backrest in a rotational energy absorber receiver, allows simplified assembly. The rotational energy absorber receiver has an uncomplicated configuration, for example as a circular through-opening. The assembly of the inner tube element on the rotational energy absorber receiver is simplified. The assembly portion is, in particular, free of energy absorption elements.

Both the features given above and the features given in the following embodiments of the device according to the invention are in each case suitable alone per se or in combination with one another to develop the subject according to the invention. The respective feature combinations are not a restriction with respect to the developments of the subject of the invention but have substantially merely an exemplary character.

Additional features and details of the invention emerge from the following description of an embodiment with the aid of the drawings.

### BRIEF DESCRIPTION OF THE DRAWINGS

FIG. 1 shows a perspective view of a vehicle seat with a rotational energy absorber according to the invention,

FIG. 2 shows an enlarged detailed view of a front view according to FIG. 1,

FIG. 3 shows a sectional view along the section line III-III in FIG. 2,

FIG. 4 shows a sectional view along the section line IV-IV in FIG. 2, and

FIG. 5 shows a perspective view of the rotational energy absorber according to FIG. 1, 2.

### DESCRIPTION OF THE PREFERRED EMBODIMENT

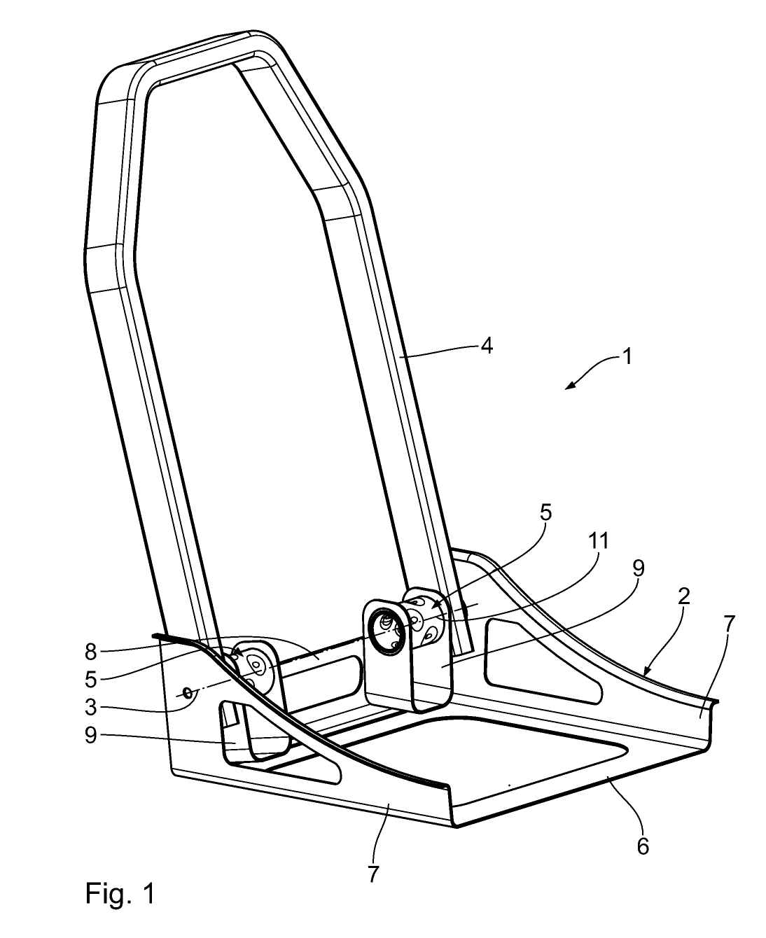

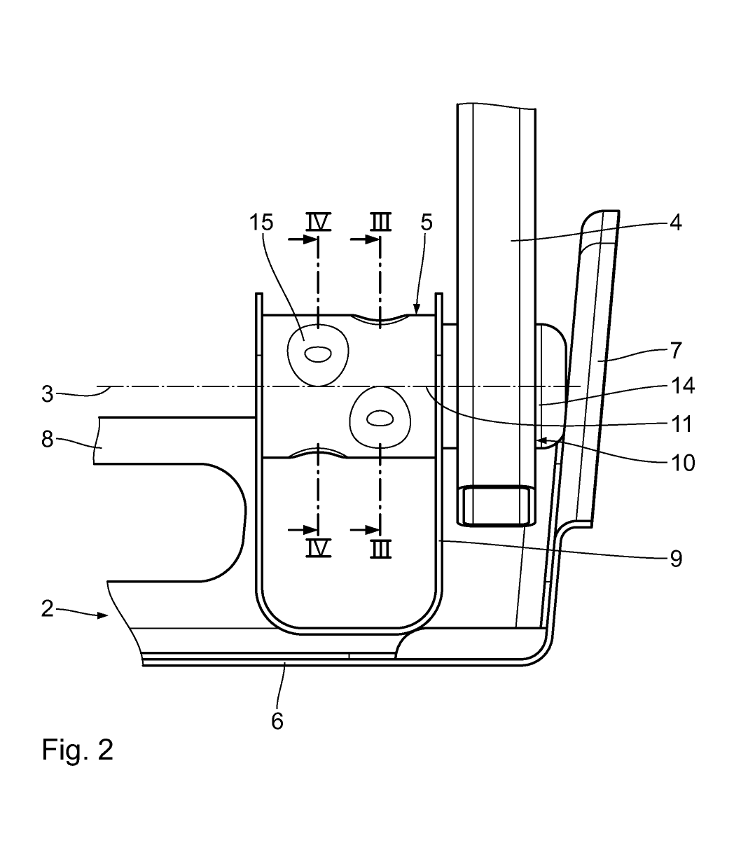

A vehicle seat 1 shown in FIGS. 1 and 2 is used in a motor vehicle, for example a car. Only the structurally decisive frame of the vehicle 1 is shown for graphic reasons. In particular, a seat cover and cushion elements are not shown.

The frame of the vehicle 1 comprises a seat shell 2 and a backrest 4 connected to the seat shell 2 about a rotational seat axis 3. The backrest 4 is connected to the seat shell 2 by two rotational energy absorbers 5 that are arranged coaxially with respect to one another and spaced apart from one another along the rotational seat axis 3.

The seat shell 2 has a frame-like structure with a substantially horizontally oriented, level base 6. The base 6 is rectangular. Two side walls 7 extend on two opposing edges of the base 6. The side walls 7 are substantially vertically oriented and formed in one piece on the base 6. In particular, the seat shell 2 is a sheet metal bent part. The rotational seat axis 3 is oriented parallel to the base 6 and in each case intersects the side wall 7. In a rear region facing the rotational seat axis 3, the side wall 7 has a first height extending in the vertical direction. In a front region remote from the rotational seat axis 3, the side wall 7 has a second height that is reduced in relation to the first height. Between the first height and the second height, the side wall 7 has a continuously reducing height course. In the rear region of the base 6, a rear wall 8 extends substantially vertically upwardly. The rear wall 8 is configured in one piece with the base 6. The rear wall 8 of the seat shell 2 has a reduced height compared to the first height of the side walls 7.

Two rotational energy absorber retainers 9 are rigidly connected to the seat shell 2. The rotational energy absorber retainers 9 are substantially U-shaped. The two free sides of the U are oriented parallel to one another and, in particular, perpendicular to the rotational seat axis 3 in each case. The intermediate side of the U connecting the two free sides to one another, with a lower side, is rigidly fastened, in particular welded, to the base 6 of the seat shell 2. The rotational energy absorber retainers 9 in each case have in the free sides, a through-opening, into which the rotational energy absorber 5 is inserted.

The backrest 4 is configured as a bent profile element. The backrest 4 has a substantially bow-like profile course. The bow has two free sides, which extend from the seat shell 2 in a backrest plane. The backrest plane is oriented transverse to the base 6 of the seat shell 2. According to the embodiment shown, the angle of inclination, with which the backrest 4 is arranged in relation to the base 6 of the seat shell 2, is about 110°. The angle of inclination between the backrest 4 and seat shell 2 is adjustable. The two free sides are brought together by means of a common curve of the backrest 4. The backrest 4 is configured in one piece. The backrest 4 is arranged between a respective side wall 7 of the seat shell 2 and a rotational energy absorber retainer 9. Provided in the region of the free ends of the free sides of the backrest 4 is a rotational energy absorber receiver 10, into which the rotational energy absorber 5 is inserted. The rotational energy absorber 5 is non-rotatably connected to the backrest 4 in the rotational energy absorber receiver 10.

The rotational energy absorber 5 is arranged with a rotational axis 11 coaxial to the rotational seat axis 3 on the vehicle seat 1. The rotational energy absorber 5 has an outer tube element 13 arranged centrally with respect to the rotational axis 11 and an inner tube element 12 arranged concentrically in the outer tube element 13. The inner tube element 12 is a metal tube, in particular a steel tube. The outer tube element 13 is a metal tube, in particular a steel tube. The essential feature for the selection of a material of the tube element 12, 13 is its cold deformability. It is necessary for this that the tube elements 12, 13 have an adequate ductility at room temperature to allow deformation of the inner tube element 12 by rotation in relation to the outer tube element 13. Additionally it is possible to stiffen the energy absorption elements 15 of the outer tube element 13. This reliably ensures a reliable deformation, in other words the drawing of a depression through the energy absorption elements 15 of the outer tube element 13 on the inner tube element 12. The inner tube element 12 can be rotated in relation to the outer tube element 13 about the rotational axis 11. The inner tube element 12 has an assembly portion 14. The assembly portion 14 is arranged projecting on the outer tube element 13 along the rotational axis 11. The inner tube element 12 is non-rotatably connected in the rotational energy absorber receiver 10 to the backrest 4 by the assembly portion 14. The rotational energy absorber 5 is non-rotatably connected to the rotational energy absorber retainer 9 of the seat shell 2 by the outer tube element 13. The inner tube element 12 and the outer tube element 13 are arranged flush on an end of the rotational energy absorber 5 opposing the assembly portion 14.

It is possible to provide a damping element, not shown, on the rotational energy absorber 5 in order to allow an additional damping of a rotational movement between the tube elements 12, 13. In particular, the damping element is configured as a blockable gas spring.

The rotational energy absorber 5 has a plurality of, according to the embodiment shown, six energy absorption elements 15.

It is important that at least one energy absorption element 15 is provided. Rotational energy is absorbed during a rotation of the tube elements 12, 13 relative to one another by the at least one energy absorption element 15. This means that rotational energy of the rotation of the tube elements 12, 13 with respect to one another is converted into deformation energy and/or heat.

According to the embodiment shown, three respective energy absorption elements 15 are arranged in a first energy absorption element arrangement and in a second energy absorption element arrangement. The energy absorption elements 15 are arranged in the energy absorption element arrangement along a peripheral line of the outer tube element 13 about the rotational axis 11. In relation to the rotational axis 11, an opening angle between two adjacent energy absorption elements 15 is 120°. This means that the energy absorption elements 15 are arranged equally spaced apart about the rotational axis 11 along the peripheral line.

The first energy absorption element arrangement is remote from the assembly portion 14. The second energy absorption element arrangement is arranged facing the assembly portion 14. It is also possible for only one energy absorption element arrangement to be provided. It is also conceivable for more than two energy absorption element arrangements, in particular at least three, in particular at least four, and in particular at most 20 energy absorption element arrangements, to be provided. The energy absorption element arrangements are arranged spaced apart from one another along the rotational axis 11. The individual energy absorption elements with their rotational angle position with respect to the rotational axis 11 are arranged with a gap. This means that no energy absorption element of the respective other energy absorption element arrangement is provided at a rotational angle position, at which an energy absorption element of the one energy absorption element arrangement is provided. This ensures that the structure of the rotational energy absorber 5 is uniform as a whole, in particular not unnecessarily impaired, in particular weakened.

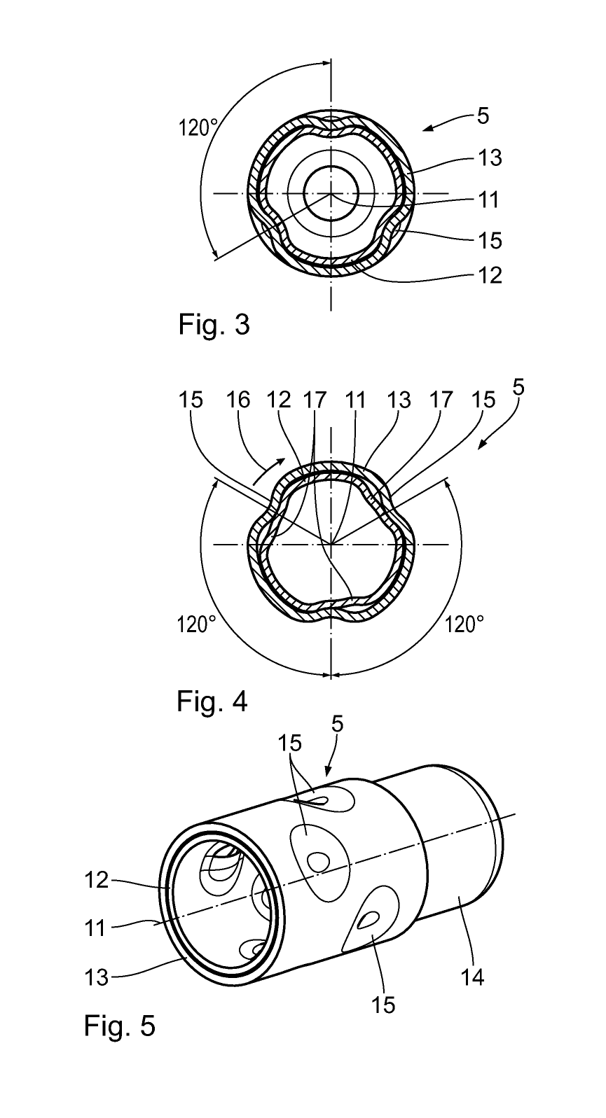

FIG. 3 shows a sectional view of the second energy absorption element arrangement. FIG. 4 shows a sectional view of the first energy absorption element arrangement.

Both the inner tube element 12 and the outer tube element 13 in each case have three energy absorption elements 15. The energy absorption elements 15 are configured as radially inwardly projecting protrusions. According to the embodiment shown, the energy absorption elements 15 are configured as beads. The beads have a slot shape in a development of the respective outer contour of the inner tube element 12 or of the outer tube element 13. The offset arrangement of the energy absorption elements 15 in the two different energy absorption element arrangements is clear from the sectional views in FIGS. 3 and 4. Energy absorption elements 15 are arranged at the 12 o'clock position in the sectional view in FIG. 3, in other words in the second energy absorption element arrangement. The two further energy absorption elements 15 are arranged at rotational angles of +/−120° about the rotational axis 11. No energy absorption element 15 is provided at a 6 o'clock position in the second energy absorption element arrangement.

An energy absorption element 15 is arranged in the 6 o'clock position in the first energy absorption element arrangement according to FIG. 4. The further energy absorption elements 15 are arranged at a rotational angle of +/−120° about the rotational axis 11. No energy absorption element 15 is arranged at the 12 o'clock position in the first energy absorption element arrangement.

The second energy absorption element will be described in more detail below. It is essential that the protrusions of the inner tube element 12 are configured to be geometrically similar to the respectively corresponding protrusions of the outer tube element 13 in such a way that an outer face of the inner protrusion of the inner tube element 12 rests over the entire area on an inner face of the corresponding protrusion of the outer tube element 13.

In the first energy absorption element arrangement according to FIG. 4, the protrusions of the inner tube element 12 are configured as free-running protrusions. An energy absorption-free rotation is made possible along a rotational direction 16 about the rotational axis 11 according to the free-running protrusion. This is made possible in that the protrusion of the inner tube element 12, viewed in the rotational direction 16, has a secondary protrusion 17 to the protrusion of the outer tube element 13. The contour of the inner tube element 12 is substantially geometrically similar to the contour of the outer tube element 13. The contours only differ from one another in the region of the secondary protrusion 17. In the region of the secondary protrusion 17, the contour of the inner tube element 12 is radially inwardly impressed in relation to that of the outer tube element 13. This means that in the region of the secondary protrusion 17, the inner tube element 12 is arranged spaced apart from the outer tube element 13. It is essential for the free-running function of the energy absorption elements of the first energy absorption element arrangement that the protrusion of the inner tube element 12 is arranged radially and/or tangentially spaced apart in relation to the rotational axis 11 from the protrusion of the outer tube element 13, at least in portions.

The function of the rotational energy absorber 5 will be described in more detail below with the aid of the vehicle seat 1. Upon a torque stressing of the vehicle seat 1, for example as a result of an impact of a motor vehicle, in which the vehicle seat 1 is attached, a torque is applied to the backrest 4 in relation to the seat shell 2 about the rotational seat axis 3. This application of a torque about the rotational seat axis 3 directly brings about an application of a torque of the two rotational energy absorbers 5 about the respective rotational axis 11, which is oriented coaxially to the rotational seat axis 3. A rotational movement of the backrest 4 about the rotational seat axis 3 brings about a rotational movement of the inner tube element 12, which is non-rotatably connected to the backrest 4 by the assembly portion 14. Because of the rotatable arrangement of the inner tube element 12 in the outer tube element 13, a rotation of the two tube elements 12, 13 takes place relative to one another about the rotational axis 11. The rotation of the inner tube element 12 in relation to the outer tube element 13 means that the beads of the outer tube element 13 cause a reshaping of the inner tube element 12. The deformation takes place in that the energy absorption elements 15 of the outer tube element 13 draw a depression oriented in the tangential direction into the inner tube element 12. Owing to this reshaping process, the rotational energy is converted into deformation energy and/or heat. Depending on the geometric configuration of the energy absorption elements 15 and/or depending on the number of energy absorption elements, the amount of energy to be converted can be adjusted. The maximum torque to be absorbed can, in particular, be influenced for the rotational energy absorber 5 in that the depth of the energy absorption elements is changed. The greater the depth of the energy absorption element, the greater the deformation work achieved during the rotation, in other words the absorbed deformation energy. This applies analogously to the number of energy absorption elements 15. The greater the number of energy absorption elements 15, the greater the deformation work achieved thereby, and therefore the deformation energy to be absorbed. The impressed, groove-like depression through the energy absorption elements of the outer tube element 13 thus extends along the peripheral line of the respective energy absorption element arrangement.

Upon a loading of the backrest 4 in such a way that the inner tube element 12 is loaded along the rotational direction 16, in other words in the clockwise direction according to FIG. 3, 4, the energy absorption elements 15 of the second energy absorption element arrangement bring about a direct energy absorption. The energy absorption elements, which are provided in the first energy absorption element arrangement, with a free-running function firstly do not bring about any energy absorption as the inner tube element 12 is arranged spaced apart from the outer tube element 13 as a result of the secondary protrusions 17. An actuation in such a way that the inner tube element 12 is actuated counter to the rotational direction 16, in other words in the anti-clockwise direction according to FIG. 3, 4, means that an energy absorption also takes place immediately in the first energy absorption element arrangement according to FIG. 4.

As soon as the rotational angle is great enough, in particular reaches about 120°, an energy absorption element 15 of the outer tube element 13 reaches an already drawn groove-shaped depression of the preceding energy absorption element 15 arranged in the peripheral direction on the outer tube element 13. The torque to be further absorbed is then reduced. This means that the backrest 4 can yield.

What is claimed is:

1. A rotational energy absorber for a vehicle seat comprising
a. a rotational axis,
b. an outer tube element arranged centrally with respect to the rotational axis,
c. an inner tube element arranged concentrically in the outer tube element,
d. at least one energy absorption element to absorb rotational energy, wherein the inner tube element and the outer tube element are arranged rotatably relative to one another about the rotational axis.

2. A rotational energy absorber according to claim 1, wherein the outer tube element has at least one energy absorption element.

3. A rotational energy absorber according to claim 1, wherein the inner tube element has at least one energy absorption element.

4. A rotational energy absorber according to claim 1, comprising a plurality of energy absorption elements, which are arranged in an energy absorption element arrangement along a peripheral line about the rotational axis on at least one of the outer tube element and on the inner tube element.

5. A rotational energy absorber according to claim 4, comprising at least a first energy absorption element arrangement and a second energy absorption element arrangement, which are arranged spaced apart from one another along the rotational axis.

6. A rotational energy absorber according to claim 5, wherein the energy absorption elements of the first energy absorption element arrangement are arranged at a first rotational angle about the rotational axis, which differs from a second rotational angle of the energy absorption elements of the second energy absorption element arrangement.

7. A rotational energy absorber according to claim 1, wherein the at least one energy absorption element is a radially projecting protrusion on at least one of the inner tube element and the outer tube element.

8. A rotational energy absorber according to claim 1, wherein the at least one energy absorption element is a bead.

9. A rotational energy absorber according to claim 7, wherein a protrusion of the inner tube element rests over the entire surface on a corresponding protrusion of the outer tube element.

10. A rotational energy absorber according to claim 7, wherein a protrusion of the inner tube element is configured as a free-running protrusion.

11. A rotational energy absorber according to claim 10, wherein the protrusion of the inner tube element ensures an energy absorption-free rotation along a rotational direction about the rotational axis.

12. A rotational energy absorber according to claim 10, wherein the protrusion of the inner tube element is arranged at least one of radially and tangentially spaced apart in portions from the protrusion of the outer tube element.

13. A rotational energy absorber according to claim 1, comprising a damping element.

14. A rotational energy absorber according to claim 1, comprising a blockable gas spring.

15. A vehicle seat with
a. a seat shell,
b. a backrest connected to the seat so as to be rotatable about a rotational seat axis and
c. at least one rotational energy absorber according to any one of the preceding claims.

16. A vehicle seat according to claim 15, wherein the rotational seat axis and the rotational axis are arranged coaxially.

17. A vehicle seat according to claim 15, wherein the outer tube element of the rotational energy absorber is non-rotatably fastened with respect to the rotational axis on the seat shell.

18. A vehicle seat according to claim 15, wherein the inner tube element of the rotational energy absorber is non-rotatably fastened with respect to the rotational axis on the backrest.

19. A vehicle seat according to claim 18, wherein the inner tube element has an assembly portion which is arranged for non-rotatable connection to the backrest in a rotational energy absorber receiver.

20. A vehicle seat according to claim 18, wherein the assembly portion projects along the rotational axis on the outer tube element.
